(19) United States
(12) Patent Application Publication
(10) Pub. No.: US 2025/0148336 A1
(43) Pub. Date: May 8, 2025

(54) QUBIT THERMAL STATE INITIALISATION

(71) Applicant: IQM FINLAND OY, Espoo (FI)

(72) Inventors: Hao HSU, Espoo (FI); Hermanni HEIMONEN, Espoo (FI); Jami RÖNKKÖ, Espoo (FI); Vasilii SEVRIUK, Espoo (FI); Wei LIU, Espoo (FI)

(21) Appl. No.: 18/836,919

(22) PCT Filed: Feb. 16, 2022
(86) PCT No.: PCT/FI2022/050096

§ 371 Date: Aug. 8, 2024

(51) Int. Cl. G06N 10/40

(52) U.S. Cl. CPC G06N 10/40

(57) ABSTRACT

It is an objective to provide an arrangement for initialising at least one qubit to a thermal state. According to an embodiment, an arrangement for initialising at least one qubit to a thermal state comprises: at least one qubit; a thermal bath structure selectively couplable to the at least one qubit, wherein the selective coupling is controllable using at least one coupling control signal, and wherein an effective temperature of the thermal bath structure is controllable via a temperature control signal; and a control unit configured to: set the effective temperature of the thermal bath structure to a target effective temperature via the temperature control signal; and initialise the at least one qubit to a thermal state by coupling the at least one qubit to the thermal bath structure in the target effective temperature using the at least one coupling control signal.

### TECHNICAL FIELD

The present disclosure relates to quantum computing, and more particularly to an arrangement for initialising at least one qubit to a thermal state, to a method for initialising at least one qubit to a thermal state, and to a quantum computing system.

### BACKGROUND

In quantum computing, in addition to needing to prepare qubits in some particular states, it may be necessary to initialise qubits to thermal states. This may be the case for, for example, quantum algorithms based on statistical outcomes, continuous time quantum information processing, and quantum simulations. Current solutions based on the conventional qubit control can be demanding in terms of timing and parameter establishment. These solutions can also require additional step in the classical part of the algorithm.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide an arrangement for initialising at least one qubit to a thermal state, a method for initialising at least one qubit to a thermal state, and a quantum computing system. The foregoing and other objectives are achieved by the features of the independent claims. Further implementation forms are apparent from the dependent claims, the description and the figures. The solutions disclose herein can relax timing precision requirements and reduce the number of parameters needed to be controlled for qubit thermal state initialisation.

According to a first aspect, an arrangement for initialising at least one qubit to a thermal state comprises at least one qubit; a thermal bath structure selectively couplable to the at least one qubit, wherein the selective coupling is controllable using at least one coupling control signal, and wherein an effective temperature of the thermal bath structure is controllable via a temperature control signal; and a control unit configured to: set the effective temperature of the thermal bath structure to a target effective temperature via the temperature control signal; and initialise the at least one qubit to a thermal state by coupling the at least one qubit to the thermal bath structure in the target effective temperature using the at least one coupling control signal. The arrangement can, for example, efficiently initialise the at least one qubit into a thermal state.

In an implementation form of the first aspect, the arrangement further comprises a tuneable coupler, wherein the at least one qubit is selectively couplable to the thermal bath structure via the tuneable coupler, and wherein the at least one coupling control signal controls the selective coupling at least via the tuneable coupler. The arrangement can, for example, control the coupling between the at least one qubit and the thermal bath structure via the tuneable coupler.

In another implementation form of the first aspect, the tuneable coupler comprises a tuneable two-level quantum system, a tuneable resonator, and/or a tuneable filter. The arrangement can, for example, efficiently control the coupling between the at least one qubit and the thermal bath structure via the tuneable two-level quantum system, the tuneable resonator, and/or the tuneable filter.

In another implementation form of the first aspect, the arrangement further comprises a bandpass filter between the at least one qubit and the thermal bath structure, wherein a passband of the bandpass filter comprises a frequency corresponding to an energy difference between a ground state of the at least one qubit and a lowest excited state of the at least one qubit. The arrangement can, for example, initialise the at least one qubit into a thermal state while the bandpass filter allows transitions between the states of the computational basis of the at least one qubit.

In another implementation form of the first aspect, at least one stopband of the bandpass filter comprises at least a frequency corresponding to an energy difference between a second lowest excited state of the at least one qubit and the lowest excited state of the at least one qubit and/or a frequency corresponding to an energy difference between the second lowest excited state of the at least one qubit and the ground state of the at least one qubit. The arrangement can, for example, initialise the at least one qubit into a thermal state while the bandpass filter can block transitions from the computational basis of the at least one qubit into other states. Thus, the thermal state can be a mixed state of the computational basis.

In another implementation form of the first aspect, the thermal bath structure comprises a resistive element and/or a linear resonator. The arrangement can, for example, efficiently initialise the at least one qubit into a thermal state via the resistive element and/or the linear resonator.

In another implementation form of the first aspect, the thermal bath structure comprises at least one normal metal-insulator-superconductor, NIS, junction, and the temperature control signal corresponds to a voltage over the NIS junction. The arrangement can, for example, efficiently initialise the at least one qubit into a thermal state using the NIS junction.

In another implementation form of the first aspect, the at least one coupling control signal comprises the voltage over the NIS junction. The arrangement can, for example, control the coupling between the at least one qubit and the thermal bath structure via the voltage over the NIS junction.

In another implementation form of the first

10 aspect, the thermal bath structure comprises a quantum-circuit refrigerator, QCR, comprising at least one superconductor—insulator—normal metal—insulator—superconductor, SINIS, junction, and wherein the temperature control signal corresponds to a voltage over the SINIS junction. The arrangement can, for example, efficiently initialise the at least one qubit into a thermal state using the QCR.

In another implementation form of the first aspect, the at least one coupling control signal comprises the voltage over the SINIS junction. The arrangement can, for example, control the coupling between the at least one qubit and the QCR via the voltage over the SINIS junction.

In another implementation form of the first aspect, the QCR further comprises a gate coupled to the normal metal of the SINIS junction, and wherein the at least one coupling control signal further comprises a voltage of the gate. The arrangement can, for example, control the coupling between the at least one qubit and the QCR via the gate voltage.

In another implementation form of the first aspect, the at least one qubit comprises at least one Josephson junction.

In another implementation form of the first aspect, the at least one qubit comprises at least one superconductive qubit.

According to a second aspect, a quantum computing system comprises a plurality of arrangements according to the first aspect.

According to a third aspect, a method for initialising at least one qubit to a thermal state using a thermal bath structure selectively couplable to the at least one qubit, wherein the selective coupling is controllable using at least one coupling control signal, and wherein an effective temperature of the thermal bath structure is controllable via a temperature control signal, comprises: setting the effective temperature of the thermal bath structure to a target effective temperature via the temperature control signal; and initialising the at least one qubit to a thermal state by coupling the at least one qubit to the thermal bath structure in the target effective temperature using the at least one coupling control signal.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a schematic representation of an arrangement for initialising at least one qubit to a thermal state according to an embodiment;

FIG. 2 illustrates a schematic representation of an arrangement for initialising at least one qubit to a thermal state further comprising a tuneable coupler according to an embodiment;

FIG. 3 illustrates a schematic representation of an arrangement for initialising at least one qubit to a thermal state further comprising a bandpass filter according to an embodiment;

FIG. 4 illustrates a schematic representation of qubit states according to an embodiment;

FIG. 5 illustrates a schematic representation of a frequency response of a bandpass filter according to an embodiment;

FIG. 6 illustrates a schematic representation of a quantum circuit refrigerator according to an embodiment;

FIG. 7 illustrates a schematic representation of a quantum circuit refrigerator further comprising a gate according to an embodiment;

FIG. 8 illustrates a circuit model representation of a quantum circuit refrigerator further comprising a gate according to an embodiment;

FIG. 9 illustrates a plot representation of a damping rate of a QCR as a function a bias voltage;

FIG. 10 illustrates a plot representation of an effective temperature of a QCR as a function of a bias voltage;

FIG. 11 illustrates a plot representation of a damping rate of a QCR as a function a gate voltage;

FIG. 12 illustrates a plot representation of an effective temperature of a QCR as a function of a gate voltage;

FIG. 13 illustrates a schematic representation of a control unit according to an embodiment; and

FIG. 14 illustrates a flow chart representation of a method for initialising at least one qubit to a thermal state according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

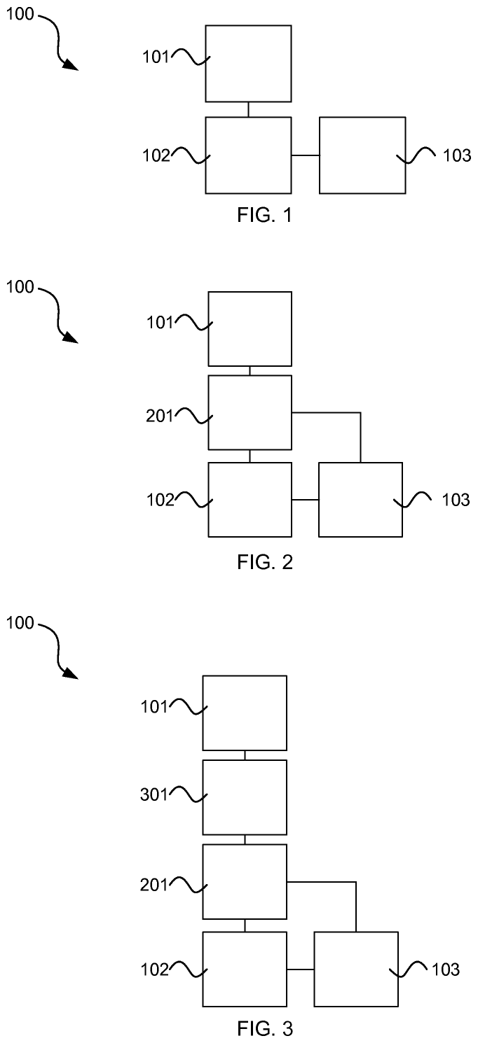

FIG. 1 illustrates a schematic representation of an arrangement for initialising at least one qubit to a thermal state according to an embodiment.

According to an embodiment, the arrangement 100 for initialising at least one qubit 101 to a thermal state comprises at least one qubit 101 and a thermal bath structure 102 selectively couplable to the at least one qubit 101. The selective coupling may be controllable using at least one coupling control signal and an effective temperature of the thermal bath structure 102 may be controllable via a temperature control signal.

The thermal bath structure 102 may comprise any structure that can function as a thermal bath for the at least one qubit 101 and the effective temperature of which can be controlled.

The thermal bath structure 102 may also be referred to as an energy relaxation structure, a controllable environment, a controllable energy dissipation structure, an engineered environment, a bath, a dissipation source, or similar.

The at least one coupling signal may comprise one or more coupling signals. Different coupling signals may control the coupling between the at least one qubit 101 and the thermal bath structure 102 via different mechanisms such as those disclosed herein.

The at least one coupling control signal may also be referred to as a coupling control voltage, a coupling control pulse, a coupling bias voltage, or similar.

The temperature control signal may also be referred to as a temperature control voltage, a temperature control pulse, a temperature bias voltage, or similar.

Herein, an effective temperature of the thermal bath structure 102 may refer to a temperature in which a system, such as the at least one qubit 101, connected to the thermal bath structure 102 sees the thermal bath structure 102 to be in. Thus, the connected system physically behaves in a way it would behave if it were coupled to a thermal bath in the effective temperature. The thermal bath structure 102 may be populated with the number of photons corresponding to the effective temperature. The effective temperature of the thermal bath structure 102 can depend on the physical implementation of the thermal bath structure 102, the coupling scheme, and the system which it is coupled to. In any particular case the effective temperature can be calculated based on the temperature of the energy modes that are coupled to the targeted mode. For example, in the case of a resonator coupled to a qubit, the effective temperature can be calculated based on the number of the photons interacting with the qubit.

The thermal bath structure 102 may be electromagnetically coupled/connected to the at least one qubit 101.

Herein, when two elements are electromagnetically connected/coupled, the elements may have an electromagnetic connection between each other. The electromagnetic connection may comprise any number of electrical components/elements, such as capacitors, inductors, mutual inductances, transmission lines etc.

It should be appreciated that although the at least one qubit 101 and the thermal bath structure 102 may be electromagnetically connected continuously, the coupling between the at least one qubit 101 and the thermal bath structure 102 may be selective.

In some embodiments, the at least one coupling control signal may directly control the coupling strength between the at least one qubit 101 and the thermal bath structure 102. For example, the coupling strength between the at least one qubit 101 and the thermal bath structure 102 may be linearly dependent on the at least one coupling control signal. In other embodiments, the at least one coupling control signal may control the coupling strength between the at least one qubit 101 and the thermal bath structure 102 indirectly. For example, the at least one coupling control signal may be a radio frequency (RF) signal and the coupling strength between the at least one qubit 101 and the thermal bath structure 102 may depend on the at least one coupling control signal in some non-linear fashion.

Herein, when the coupling between the thermal bath structure 102 and other components, such as the at least one qubit 101, is controllable/selective, the strength of interaction between the thermal bath structure 102 and the other components may be controlled and/or turned on or off. It should be appreciated that even if there is a continuous connection, such as an electrical/capacitive/inductive connection, between two elements, the interaction between the elements can be tuned.

The arrangement 100 may further comprise a control unit 103 configured to set the effective temperature of the thermal bath structure 102 to a target effective temperature via the temperature control signal and initialise the at least one qubit 101 to a thermal state by coupling the at least one qubit 101 to the thermal bath structure 102 in the target effective temperature using the at least one coupling control signal.

The target effective temperature may be pre configured into the control unit 103. For example, the control unit 103 may be configured to control quantum computations performed using the at least one qubit 101. The target effective temperature may be configured based on what is needed, such as what type of thermal state, for the quantum computation.

Herein, a thermal state may refer to, for example, any mixed state of the at least one qubit 101. When at least one qubit 101 is in a thermal state, the state of at least one qubit 101 may be described using a density matrix instead of a state vector or a wavefunction.

The arrangement 100 can use the thermal bath structure 102 as a system with controlled temperature and a possibility to couple and uncouple it to the one or several qubits to initialise or keep the qubit(s) in a statistical thermal state. The control of the thermal bath structure 102 effective temperature and the coupling between the at least one qubit 101 and the thermal bath structure 102 can be implemented in various ways.

Preparing thermal states via the arrangement 100 can have advantages in the convergence speed of certain quantum simulations over, for example, the string sampling method, where when a quantum algorithm requires averaging over a thermal state, the qubits are initialized in strings sampled from a thermal state, typically by a classical computer. It might be possible that the number of samples that need to be reached for a given precision could be reduced by even a factor of ten even though the asymptotic convergence rates may be the same.

Compared to a thermal state preparation scheme, where a qubit is entangled to an ancilla qubit and the ancilla is disregarded, the arrangement 100 can provide an improvement of factor 2 in the qubit count.

The arrangement 100 can enable the resetting to thermal states of many-body Hamiltonians if the thermal bath structure 102 is applied to the qubits while couplings between the qubits are turned on. Alternatively or additionally, the thermal bath structure 102 can be coupled to each qubit separately. There may be a tuneable coupler between the thermal bath structure 102 and each qubit or one tuneable coupler for all qubits.

The qubit thermal state initialisation can be seen as a specific part of quantum simulations, where the digital qubit control is replaced by an analogue device. However, the arrangement 100 may not be used as a part of the computation but only for the initialization and re-initialization of the at least one qubit 101.

According to an embodiment, the at least one qubit 101 comprises at least one superconductive qubit.

According to an embodiment, the at least one qubit 101 comprises at least one Josephson junction.

The at least one qubit 101 may comprise, for example, a transmon qubit, a flux qubit, a charge qubit, a phase qubit, a fluxonium qubit, or any other type of qubit.

Although some embodiments may be disclosed herein with reference to a certain type of qubit, these qubit types are only exemplarily. In any embodiment disclosed herein, the at least one qubit 101 may be implemented in various ways and using various technologies.

The arrangement 100 may be embodied in, for example, a quantum computing device. Such a quantum computing device may comprise a plurality of qubits for performing quantum computation. Each such qubit may be implemented using the arrangement 100. Alternatively, the at least one qubit 101 may comprise a plurality of qubits and the thermal bath structure 102 can initialise the plurality of qubits to a thermal state.

The arrangement 100 may be realized, for example, in a superconducting circuit architecture.

When the arrangement 100 is operational, the at least one qubit 101 and the thermal bath structure 102 may be physically located in a cryostat or similar.

The cryostat may cool the at least one qubit 101 and other components of the arrangement 100, such as the thermal bath structure 102, to cryogenic temperatures. This may be required if the at least one qubit 101 correspond to, for example, a superconductive qubit.

FIG. 2 illustrates a schematic representation of an arrangement for initialising at least one qubit to a thermal state further comprising a tuneable coupler according to an embodiment.

According to an embodiment, the arrangement 100 further comprises a tuneable coupler 201. The at least one qubit 101 may be selectively couplable to the thermal bath structure 102 via the tuneable coupler 201. The at least one coupling control signal can control the selective coupling at least via the tuneable coupler 201.

The tuneable coupler 201 may comprise, for example, a tuneable two-level quantum system, a tuneable resonator, and/or a tuneable filter.

For example, the tuneable coupler 102 may be implemented as a two-level quantum system in a similar fashion as the at least one qubit 101. A tuneable resonator may comprise, for example, a tuneable RF resonator. A tuneable filter may comprise, for example, a tuneable RF filter.

In some embodiments, the at least one coupling control signal may control the coupling via the tuneable coupler and the thermal bath structure 102. For example, in some embodiments, the temperature control signal may also affect the coupling between the at least one qubit 101 and the thermal bath structure 102. The tuneable coupler may introduce an additional parameter for controlling the coupling. Thus, the tuneable coupler 201 can enable the arrangement 100 to keep the coupling between the at least one qubit 101 and the thermal bath structure 102 substantially unchanged while controlling the effective temperature of the thermal bath structure 102.

FIG. 3 illustrates a schematic representation of an arrangement for initialising at least one qubit to a thermal state further comprising a bandpass filter according to an embodiment.

According to an embodiment, the arrangement 100 further comprises a bandpass filter 301 between the at least one qubit 101 and the thermal bath structure 201. A passband of the bandpass filter 301 may comprise a frequency corresponding to an energy difference between a ground state of the at least one qubit 101 and a lowest excited state of the at least one qubit 101.

The bandpass filter may be implement using, for example, a resonator or a more complicated structure.

The embodiment of FIG. 3 only illustrates an example of the ordering of the tuneable coupler 201 and the bandpass filter 301 between at least one qubit 101 and the thermal bath structure 102. In some embodiments, the order of the tuneable coupler 201 and the bandpass filter 301 may be reversed. In some other embodiments, the arrangement 100 may comprise the bandpass filter 301 without the tuneable coupler 201.

In some embodiments, the tuneable coupler 201 and the bandpass filter 301 may be implemented using a single device/circuit. For example, the tuneable coupler 201 and the bandpass filter 301 may be implemented as a tuneable resonator that can function as both the tuneable coupler 201 and as the bandpass filter 301.

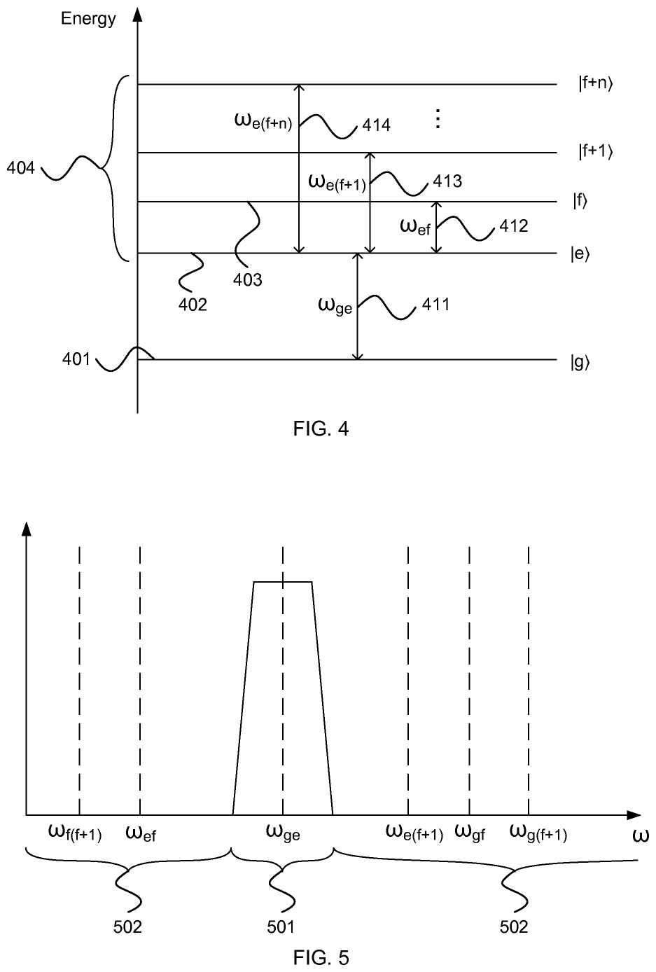

FIG. 4 illustrates a schematic representation of qubit states according to an embodiment.

The at least one qubit 101 may have a ground state |g [symbol] 401. Herein, the ground state 401 may refer to a quantum state of the at least one qubit 101 with the lowest energy.

The at least one qubit 101 may further have a plurality of excited states 404. The plurality of excited states 404 may comprise a lowest excited state |e [symbol] 402. Herein, the lowest excited state |e [symbol] 402 may refer to a quantum state of the at least one qubit 101 with the second lowest energy.

The ground state |g [symbol] 401 and the lowest excited state |e [symbol] 402 of the at least one qubit 101 may correspond to the computational basis of the at least one qubit 101. For example, the ground state |g [symbol] 401 may correspond to the |0 [symbol] state of the at least one qubit 101 and the lowest excited state |e [symbol] 402 may correspond to the |1 [symbol] state of the at least one qubit 101 or vice versa.

The energy difference 411 between the ground state |g [symbol] 401 and the lowest excited state |e [symbol] 402 may correspond to a frequency ω_{ge}. The frequency ω_{ge} may also be referred to as the resonance frequency and/or qubit frequency of the at least one qubit 101.

The plurality of excited states 404 may further comprise a second lowest excited state |f [symbol] 403. The second lowest excited state |f [symbol] 403 has a higher energy than the ground state |g [symbol] 401 and the lowest excited state |e [symbol] 402.

Herein, any excited state above the second lowest excited state |f [symbol] 403 may be denoted by |f+k [symbol] , where k refers to the position of the state above the second lowest excited state |f [symbol] 403. For example, the third lowest excited state may be denoted by |f+1 [symbol] and so on.

The plurality of excited states 404 may comprise any number of excited states. In the embodiment of FIG. 4, four excited states are illustrated. However, as is denoted in FIG. 4, there may be any number of excited states between the state |f+1 [symbol] and the state |f+n [symbol] .

FIG. 5 illustrates a schematic representation of a frequency response of a bandpass filter according to an embodiment.

In the embodiment of FIG. 5, the passband 501 of the bandpass filter 301 comprises the frequency ω_{ge} corresponding to the energy difference between the ground state |g [symbol] 401 of the at least one qubit 101 and the lowest excited state |e [symbol] 402 of the at least one qubit 101. Thus, the bandpass filter 301 may allow energy transfer from the at least one qubit 101 to the thermal bath structure 102 and vice versa at the frequency ω_{ge}. Therefore, the bandpass filter 301 can allow energy transfer between the thermal bath structure 102 and the at least one qubit 101 at such frequencies that can cause transitions between the states of the computational basis of the at least one qubit 101.

According to an embodiment, at least one stopband 502 of the bandpass filter 301 comprises at least a frequency ω_{ef} corresponding to an energy difference between a second lowest excited state |f [symbol] 403 of the at least one qubit 101 and the lowest excited state |e [symbol] 402 of the at least one qubit 101 and/or a frequency @gf corresponding to an energy difference between the second lowest excited state |f [symbol] 403 of the at least one qubit 101 and the ground state |g [symbol] 401 of the at least one qubit 101.

Thus, the bandpass filter 301 may block energy transfer between the at least one qubit 101 and the thermal bath structure 102 that could cause the at least one qubit 101 to transition to a state outside the computational basis of the at least one qubit 101.

According to an embodiment, at least one stopband 502 of the bandpass filter 301 further comprises at least a frequency ω_{e(f+1)} corresponding to an energy difference between a third lowest excited state |f+1 [symbol] of the at least one qubit 101 and the lowest excited state |e [symbol] 402 of the at least one qubit 101.

The at least one stopband 502 of the bandpass filter 301 may further comprise frequencies corresponding to various other transitions between the states of the at least one qubit 101. In the embodiment of FIG. 5, two frequencies ω_{f(f+1)}, ω_{ef} corresponding to energy differences between excited states of the at least one qubit 101 are illustrated. Since these energy differences are smaller than the energy difference between |g [symbol] and |e [symbol] , the corresponding frequencies are lower than the frequency ω_{ge}. Since the at least one stopband 502 of the bandpass filter 301 comprises these frequencies, the corresponding transitions cannot occur in the at least one qubit 101.

The at least one stopband 502 of the bandpass filter 301 may further comprises frequencies that correspond to larger energy differences than the energy gap between |g [symbol] and |e [symbol] . Three such frequencies, ω_{e(f+1)}, ω_{gf}, and ω_{g(f+1)}, are illustrated in the embodiment of FIG. 5. Thus, the bandpass filter 301 may also prevent direct transitions between the higher excited states and the ground state |g [symbol] 401.

It should be appreciated that the order of the frequencies illustrated in the embodiment of FIG. 5 is only exemplary and the order may be different depending on the physical implementation of the at least one qubit 101.

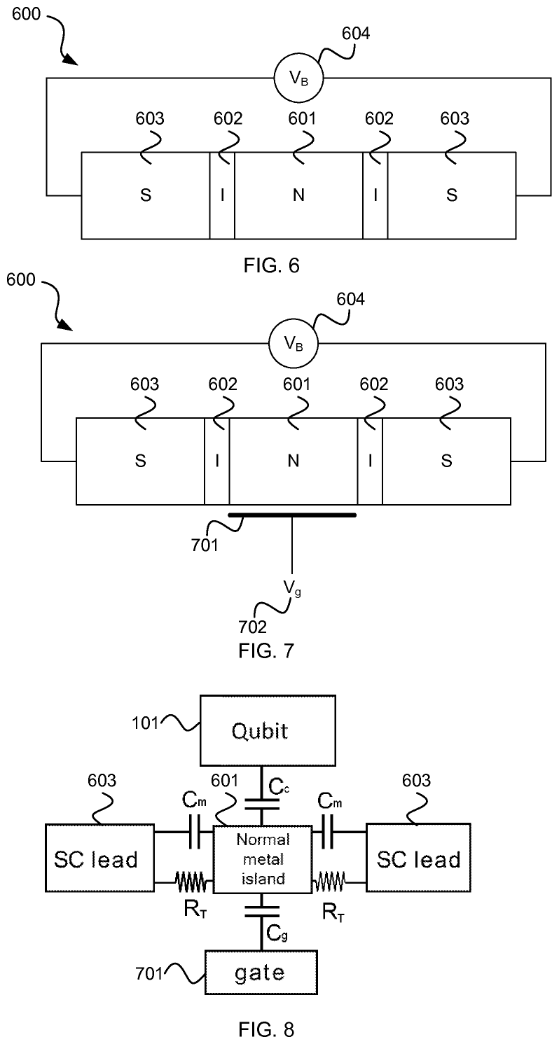

FIG. 6 illustrates a schematic representation of a quantum circuit refrigerator according to an embodiment.

According to an embodiment, the thermal bath structure 102 comprises at least one normal metal 601—insulator 602—superconductor 603 (NIS) junction, and the temperature control signal corresponds to a voltage over the NIS junction.

According to an embodiment, the thermal bath structure 102 comprises a quantum-circuit refrigerator, QCR, 600 comprising at least one superconductor 603—insulator 602—normal metal 601—insulator 602—superconductor 603 (SINIS) junction and the temperature control signal corresponds to a voltage 604 over the SINIS junction.

For example, in the embodiment of FIG. 6, the thermal bath structure 102 comprises two NIS junctions, forming a SINIS junction. Any disclosure herein in relation to the SINIS junction may also apply to the NIS junction.

The normal metal 601 may also be referred to as a normal metal island, metal island, or similar.

The voltage 604 over the SINIS junction may also be referred to as a bias voltage, SINIS junction bias voltage, QCR bias voltage, or similar.

According to an embodiment, the at least one coupling control signal comprises the voltage over the NIS junction.

According to an embodiment, the at least one coupling control signal comprises the voltage over the SINIS junction.

The QCR 600 can dissipate photon energy transferred to the QCR via photon-assisted electron tunnelling in the SINIS junction.

Photon-assisted tunnelling involves a tunnelling process where the qubit excitation energy enables a tunnelling process which otherwise is not favourable due to an energy barrier of the SINIS junction. The barrier may be the superconducting energy gap of the SINIS junction, possibly accompanied by Coulomb gap depending on the charging energies.

The at least one qubit 101 may be capacitively coupled to the QCR which can be seen as a thermal bath whose effective temperature and coupling strength to the at least one qubit 101 can be controlled with a bias voltage 604 across the SINIS junction. The effective dissipation rate can be changed over several orders of magnitude.

The energy relaxation properties of the SINIS junction can be controlled by the bias voltage V_{B} 604. In some embodiments, the bias voltage V_{B} 604 is time-dependent.

The QCR 600 may absorb photons from the at least one qubit 101 at bias voltages where an electron needs to receive an additional energy quantum from the at least one qubit 101 to overcome the Bardeen-Cooper-Schrieffer (BCS) energy gap in the superconductor 303. For example, if eV_{B}<2Δ, there is ideally only a small probability of electron tunnelling through the SINIS junction spontaneously. Moreover, if eV_{B}+hf>24, an electron can tunnel via photon-assisted tunnelling with the absorption of a photon of energy hf. Here A is the BCS gap or superconducting gap of the superconducting electrode material, V_{B} is the bias voltage, e the electron charge, h the Planck constant, and f the frequency of the photon. If, furthermore, the energy hf corresponds to the energy difference of the excited and ground states of at least one qubit, at least one qubit is in its excited state, and if the SINIS junction is electromagnetically coupled to at least one qubit, at least one qubit can relax from the excited state to the ground state through the relaxation channel provided by the photon-assisted tunnelling in the SINIS junction. However, if eV_{B}+hf<2Δ, the photon-assisted tunnelling is ideally forbidden.

The QCR 600 can provide a high degree of flexibility, a small form factor, and a relative ease of control.

In some other embodiments, the thermal bath structure 102 can be implemented in other ways.

In case of QCR temperature and coupling can be controlled internally but with a limited ability.

According to an embodiment, the thermal bath structure comprises a resistive element and/or a linear resonator.

The temperature control signal may correspond to a current running through the resistor. In embodiments with a resistive element and/or a linear resonator, the temperature control signal may comprise an RF signal sent by a transmission line.

FIG. 7 illustrates a schematic representation of a quantum circuit refrigerator further comprising a gate according to an embodiment.

According to an embodiment, the QCR 600 further comprises a gate 701 coupled to the normal metal 601 of the SINIS junction and the at least one coupling control signal further comprises a voltage 702 of the gate 701.

The gate voltage 702 can tune the chemical potential of the normal metal 601. Thus, the gate voltage 702 and the SINIS junction voltage 604 can be used for, for example, fine tuning of the coupling between the at least one qubit 101 and the QCR 600 and QCR temperature. Therefore, the SINIS junction voltage 604 and the gate voltage 702 can provide a two-dimensional parameter space for controlling the coupling and the effective temperature.

Thus, the control unit 103 can control the coupling via the voltage 604 over the SINIS junction, the gate voltage 702, the tuneable coupler 201, and/or some combination of these. Simultaneously, the control unit 103 can control the effective temperature of the QCR 600 via the voltage 604 over the SINIS junction. The gate on the normal metal island efficiency is also proportional to the charging energy. The charging energy with the gate can also be higher than without the gate.

FIG. 8 illustrates a circuit model representation of a quantum circuit refrigerator further comprising a gate according to an embodiment.

It should be appreciated that the embodiment of FIG. 8 only illustrates some electrical and physical properties of the QCR 600 and of the coupling between the QCR 600 and the at least one qubit 101 in a simplified fashion. These properties and corresponding parameters disclosed herein are only exemplary and may vary depending on the physical implementation of the arrangement 100.

R_{T} illustrated in the embodiment of FIG. 8 is a junction parameter which gives the range of the current which can flow through it. In the simplest case, R_{T} correspond to the resistance of the junction in the normal state and approximates the junction resistance at voltage above its superconductive gap. Ry can be also used in combination with the Dynes parameter to estimate the leakage current. The photon assisted tunnelling can also depend on R_{T}. R_{T} is typically in the range of tens of kiloohms.

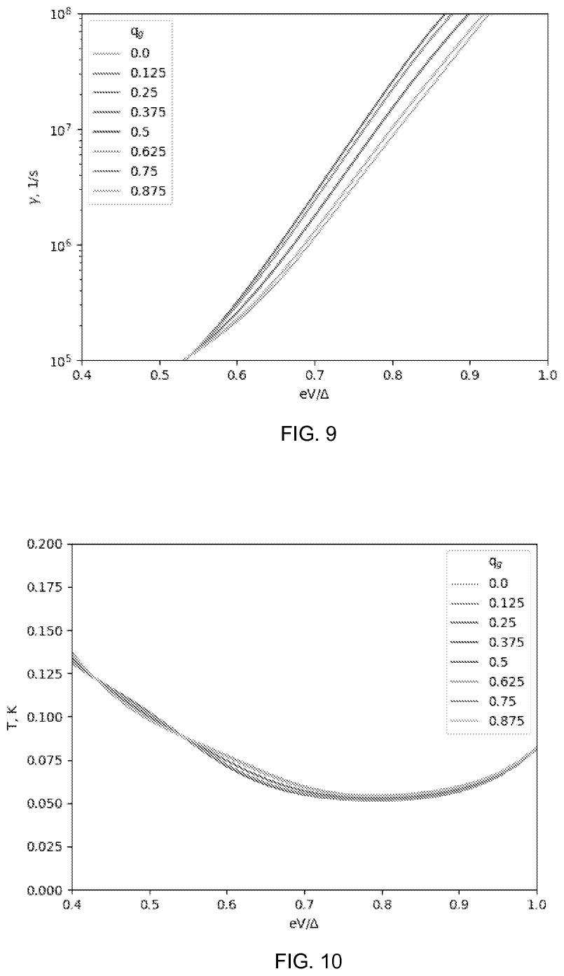

FIG. 9 illustrates a plot representation of a damping rate of a QCR as a function a bias voltage.

In the embodiments of FIGS. 9-12, the following parameters are used for the simulations. The correspondence between the parameters and the arrangement 100 is illustrate in the embodiment of FIG. 8.

-Superconducting gap parameter of the QCR: Δ=200 μeV
NIS junction capacitances of the QCR: Cₘ=0.5 fF
Electron temperature of the normal metal island of the QCR: 0.1 K
Dynes parameter of the QCR: 10⁻⁵
Qubit frequency of the at least one qubit 101: 5 GHZ
Coupling capacitance between the QCR and the at least one qubit 101: C_{c}=3.5 fF
Coulomb energy of the metal island of the QCR: 0.1Δ
R_{T}=50 kΩ

In the embodiment of FIG. 9, the QCR-induced damping rate γ is represented as a function of the bias voltage over the NIS junction (half of the voltage applied to the SINIS junction) for various different gate voltages. The NIS junction voltage is represented as eV/Δ, where e is the electron charge, V is the NIS junction voltage, and Δ is the superconducting gap parameter of the QCR.

The damping rate γ of the QCR 600 may be proportional to the strength of the coupling between the at least one qubit 101 and the QCR 600.

The gate voltage V_{g} in the is represented as q_{g}=C_{g}V_{g}/e.

FIG. 10 illustrates a plot representation of an effective temperature of a QCR as a function of a bias voltage.

In the embodiment of FIG. 10, the effective temperature of the QCR 600 is represented as a function of the bias voltage over the NIS junction for various different gate voltages.

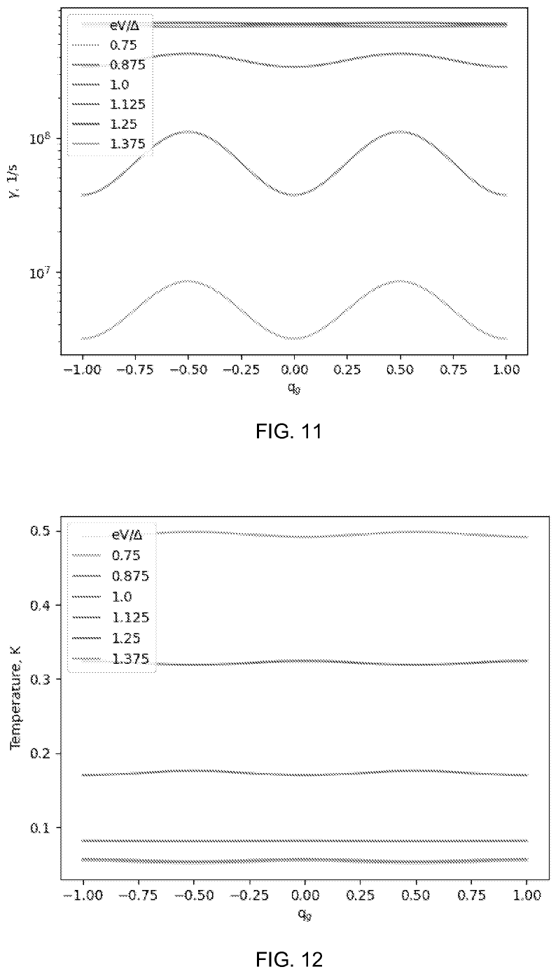

FIG. 11 illustrates a plot representation of a damping rate of a QCR as a function a gate voltage.

In the embodiment of FIG. 11, the damping rate γ of the QCR 600 is represented as a function of the gate voltage for various different bias voltages over the NIS junction.

FIG. 12 illustrates a plot representation of an effective temperature of a QCR as a function of a gate voltage.

In the embodiment of FIG. 12, the effective temperature of the QCR is represented as a function of the gate voltage for various different bias voltages over the NIS junction.

As can be seen from FIGS. 9-12, the bias voltage over the SINIS junction and the gate voltage can be used to control the effective temperature and the damping rate γ of the QCR 600. For example, the QCR 600 can be set into the target effective temperature using the bias voltage and the damping rate γ can be finetuned using the gate voltage.

It should be appreciated that the behaviour illustrated in FIGS. 9-12 may only apply for the specific parameters disclosed above.

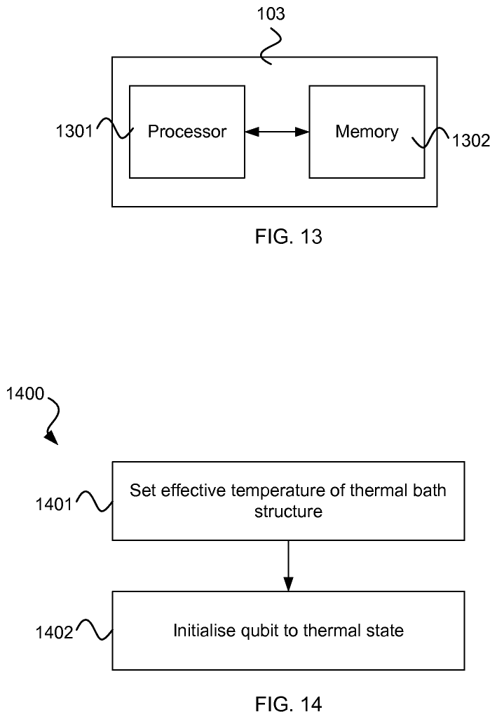

FIG. 13 illustrates a schematic representation of a control unit according to an embodiment.

The control unit 103 may comprise at least one processor 1301. The at least one processor 1301 may comprise, for example, one or more of various processing devices, such as a co-processor, a microprocessor, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hardware accelerator, a special-purpose computer chip, or the like.

The control unit 103 may further comprise a memory 1302. The memory 1302 may be configured to store, for example, computer programs and the like. The memory 1302 may comprise one or more volatile memory devices, one or more non-volatile memory devices, and/or a combination of one or more volatile memory devices and nonvolatile memory devices. For example, the memory 1302 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

The control unit 103 may further comprise other components not illustrated in the embodiment of FIG. 13. The control unit 103 may comprise, for example, an input/output bus for connecting the control unit 103 to other devices. Further, a user may control the control unit 103 via the input/output bus. The user may, for example, control quantum computation operations performed by the at least one qubit 101 via the control unit 103 and the input/output bus.

When the control unit 103 is configured to implement some functionality, some component and/or components of the control unit 103, such as the at least one processor 1301 and/or the memory 1302, may be configured to implement this functionality. Furthermore, when the at least one processor 1301 is configured to implement some functionality, this functionality may be implemented using program code comprised, for example, in the memory.

The control unit 103 may be implemented using, for example, a computer, some other computing device, or similar.

FIG. 14 illustrates a flow chart representation of a method for initialising at least one qubit to a thermal state according to an embodiment.

According to an embodiment, a method 1400 for initialising at least one qubit to a thermal state using a thermal bath structure selectively couplable to the at least one qubit, wherein the selective coupling is controllable using at least one coupling control signal, and wherein an effective temperature of the thermal bath structure is controllable via a temperature control signal comprises setting 1401 the effective temperature of the thermal bath structure to a target effective temperature via the temperature control signal.

The method 1400 may further comprise initialising 1402 the at least one qubit to a thermal state by coupling the at least one qubit to the thermal bath structure in the target effective temperature using the at least one coupling control signal.

The method 1400 may be performed by, for example, the control unit 103.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An arrangement for initialising at least one qubit to a thermal state, comprising:
at least one qubit;
a thermal bath structure selectively couplable to the at least one qubit, wherein the selective coupling is controllable using at least one coupling control signal, and wherein an effective temperature of the thermal bath structure is controllable via a temperature control signal; and
a control unit configured to:
set the effective temperature of the thermal bath structure to a target effective temperature via the temperature control signal; and
initialise the at least one qubit to a thermal state by coupling the at least one qubit to the thermal bath structure in the target effective temperature using the at least one coupling control signal.

2. The arrangement according to claim 1, further comprising a tuneable coupler, wherein the at least one qubit is selectively couplable to the thermal bath structure via the tuneable coupler, and wherein the at least one coupling control signal controls the selective coupling at least via the tuneable coupler.

3. The arrangement according to claim 2, wherein the tuneable coupler comprises a tuneable two-level quantum system, a tuneable resonator, and/or a tuneable filter.

4. The arrangement according to claim 1, further comprising a bandpass filter between the at least one qubit and the thermal bath structure, wherein a passband of the bandpass filter comprises a frequency corresponding to an energy difference between a ground state of the at least one qubit and a lowest excited state of the at least one qubit.

5. The arrangement according to claim 4, wherein at least one stopband of the bandpass filter comprises at least a frequency corresponding to an energy difference between a second lowest excited state of the at least one qubit and the lowest excited state of the at least one qubit and/or a frequency corresponding to an energy difference between the second lowest excited state of the at least one qubit and the ground state of the at least one qubit.

6. The arrangement according to claim 1, wherein the thermal bath structure comprises a resistive element and/or a linear resonator.

7. The arrangement according to claim 1, wherein the thermal bath structure comprises at least one normal metal—insulator—superconductor, NIS, junction, and wherein the temperature control signal corresponds to a voltage over the NIS junction.

8. The arrangement according to claim 7, wherein the at least one coupling control signal comprises the voltage over the NIS junction.

9. The arrangement according to claim 1, wherein the thermal bath structure comprises a quantum-circuit refrigerator, QCR, comprising at least one superconductor—insulator—normal metal—insulator—superconductor, SINIS, junction, and wherein the temperature control signal corresponds to a voltage over the SINIS junction.

10. The arrangement according to claim 9, wherein the at least one coupling control signal comprises the voltage over the SINIS junction.

11. The arrangement according to claim 9, wherein the QCR further comprises a gate coupled to the normal metal of the SINIS junction, and wherein the at least one coupling control signal further comprises a voltage of the gate.

12. The arrangement according to claim 1, wherein the at least one qubit comprises at least one Josephson junction.

13. The arrangement according to claim 1, wherein the at least one qubit comprises at least one superconductive qubit.

14. A quantum computing system comprising a plurality of arrangements according to claim 1.

15. A method for initialising at least one qubit to a thermal state using a thermal bath structure selectively couplable to the at least one qubit, wherein the selective coupling is controllable using at least one coupling control signal, and wherein an effective temperature of the thermal bath structure is controllable via a temperature control signal, the method comprising:
setting the effective temperature of the thermal bath structure to a target effective temperature via the temperature control signal; and
initialising the at least one qubit to a thermal state by coupling the at least one qubit to the thermal bath structure in the target effective temperature using the at least one coupling control signal.

16. The arrangement according to claim 10, wherein the QCR further comprises a gate coupled to the normal metal of the SINIS junction, and wherein the at least one coupling control signal further comprises a voltage of the gate.
